(19) United States
(12) Patent Application Publication
(10) Pub. No.: US 2023/0162520 A1
(43) Pub. Date: May 25, 2023

(54) IDENTIFYING WRITING SYSTEMS UTILIZED IN DOCUMENTS

(71) Applicant: ABBYY Development Inc., Dover, DE (US)

(72) Inventors: Stanislav Semenov, Moscow (RU); Ivan Zagaynov, Dolgoprudni (RU); Dmitry Solntsev, Moscow (RU); Aleksey Kalyuzhny, Nahabino (RU)

(21) Appl. No.: 17/534,704

(22) Filed: Nov. 24, 2021

(30) Foreign Application Priority Data
Nov. 23, 2021 (RU) 2021134180

(51) Int. Cl. G06K 9/00; G06K 9/32; G06T 7/11; G06K 9/62; G06T 7/77; G06N 3/04

(52) U.S. Cl. CPC G06K 9/00469; G06K 9/00979; G06K 9/3233; G06K 9/6232; G06K 9/6298; G06N 3/0472; G06T 7/11; G06T 7/77; G06T 2207/20021; G06T 2207/20076; G06T 2207/20081; G06T 2207/20084; G06T 2207/30176

(57) ABSTRACT

Systems and methods for identifying writing systems utilized in documents. An example method comprises: receiving a document image; splitting the document image into a plurality of image fragments; generating, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a respective writing system; computing an aggregated probability vector by aggregating the plurality of probability vectors, wherein each numeric element of the aggregated probability vector reflects a probability of the image containing a text associated with a writing system that is identified by an index of the numeric element within the aggregated probability vector; and responsive to determining that a maximum numeric element of the aggregated probability vector exceeds a predefined threshold value, concluding that the document image contains one or more symbols associated with a respective writing system.

### REFERENCE TO RELATED APPLICATIONS

The present application claims the benefit of priority under 35 U.S.C. §119 to Russian Patent Application No. RU2021134180 filed Nov. 23, 2021, the disclosure of which is incorporated by reference herein.

### TECHNICAL FIELD

The present disclosure is generally related to computer systems, and is more specifically related to systems and methods for identifying writing systems utilized in documents.

### BACKGROUND

A writing system is a method of visually representing verbal communication, based on a script and a set of rules regulating its use. Writing systems may be broadly classified into alphabets, syllabaries, or logographies, although some writing systems may have attributes of more than one category. In alphabets, each symbol represent a corresponding speech sounds. In abjads, vowels are not indicated. In abugidas or alpha-syllabaries, each character represents a consonant-vowel pair. In syllabaries, each symbol represents a syllable or mora. In logographies, each symbol represents a semantic unit, such as a morpheme. Some writing systems also include a special set of symbols known as punctuation which is used to aid interpretation and express nuances of the meaning of the message.

### SUMMARY OF THE DISCLOSURE

In accordance with one or more aspects of the present disclosure, an example method of identifying the writing system utilized in a document comprises: receiving, by a computer system, a document image; splitting the document image into a plurality of image fragments; generating, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector; computing an aggregated probability vector by aggregating the plurality of probability vectors, wherein each numeric element of the aggregated probability vector reflects a probability of the image containing a text associated with a writing system that is identified by an index of the numeric element within the aggregated probability vector; and responsive to determining that a maximum numeric element of the aggregated probability vector exceeds a predefined threshold value, concluding that the document image contains one or more symbols associated with a writing system that is identified by an index of the maximum numeric element within the aggregated probability vector.

In accordance with one or more aspects of the present disclosure, an example system comprises a memory and a processor coupled to the memory. The processor is configured to: receive a document image; split the document image into a plurality of image fragments; generate, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector; compute an aggregated probability vector by aggregating the plurality of probability vectors, wherein each numeric element of the aggregated probability vector reflects a probability of the image containing a text associated with a writing system that is identified by an index of the numeric element within the aggregated probability vector; and responsive to determining that a maximum numeric element of the aggregated probability vector exceeds a predefined threshold value, conclude that the document image contains one or more symbols associated with a writing system that is identified by an index of the maximum numeric element within the aggregated probability vector.

In accordance with one or more aspects of the present disclosure, an example computer-readable non-transitory storage medium comprises executable instructions that, when executed by a computer system, cause the computer system to: receive a document image; split the document image into a plurality of image fragments; generate, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector; compute an aggregated probability vector by aggregating the plurality of probability vectors, wherein each numeric element of the aggregated probability vector reflects a probability of the image containing a text associated with a writing system that is identified by an index of the numeric element within the aggregated probability vector; and responsive to determining that a maximum numeric element of the aggregated probability vector exceeds a predefined threshold value, conclude that the document image contains one or more symbols associated with a writing system that is identified by an index of the maximum numeric element within the aggregated probability vector.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of an example method of identifying the writing system utilized in a document, in accordance with one or more aspects of the present disclosure;

FIG. 2 depicts a flow diagram of another example method of identifying the writing system utilized in a document, in accordance with one or more aspects of the present disclosure;

FIG. 3 depicts a flow diagram of yet another example method of identifying the writing system utilized in a document, in accordance with one or more aspects of the present disclosure;

FIG. 4 schematically illustrates an example neural network architecture that may be utilized by the systems and methods of the present disclosure;

FIG. 5 depicts a component diagram of an example computer system which may be employed for implementing the methods described herein.

### DETAILED DESCRIPTION

Described herein are methods and systems for identifying writing systems utilized in document images. The systems and methods of the present disclosure process indicia-bearing images of various media (such as printed or handwritten paper documents, banners, posters, signs, billboards, and/or other physical objects bearing visible graphemes on one or more of their surfaces). “Grapheme” herein shall refer to the elementary unit of an alphabet. A grapheme may be represented, e.g., by a logogram representing a word or a morpheme, a syllabic character representing a syllable, or an alphabetic characters representing a phoneme.

The systems and methods of the present disclosure are capable of recognizing several writing systems, including, e.g., Latin/Cyrillic alphabets, Korean alphabet, Chinese/Japanese logographies, and/or Arabic abjad. In some implementations, identifying the writing system utilized in a document is a pre-requisite for performing the optical character recognition (OCR) of the document image. In an illustrative example, the systems and methods described herein may be employed for determining values of one or more parameters of mobile OCR applications, including the writing system and/or the image orientation.

An example method of identifying the writing system utilized by an input image splits the original image into a predefined number of rectangular fragments (e.g., into 3 x 3 regular grid of nine rectangular fragments, 4 x 4 regular grid of 16 rectangular fragments, 5 x 5 regular grid of 25 rectangular fragments, etc.). Upon having been compressed to a predefined size (e.g., 224 × 224 pixels), the rectangular fragments are fed to a neural network which applies a set of functional transformations to a plurality of inputs (e.g., image pixels) and then utilizes the transformed data to perform pattern recognition. The neural network produces a numeric vector that includes N+1 values where N is the number of writing systems recognizable by the neural network), such that i-th elements of the vector reflects the probability of the image fragment depicting symbols of the i-th writing system, and the last element of the vector reflects the probability of the image fragment depicting no recognizable symbols. All the vectors produced by the neural network for the set of fragments of the input image are then added together, and the resulting vector is then normalized. If the maximum value, among all elements of the normalized resulting vector, exceeds a predefined threshold, the image is found to contain symbols of the writing system identified by the index of the maximum element of the vector. Otherwise, two writing systems that scored the two largest values are returned.

Thus, the system and methods of the present disclosure improve the efficiency of optical character recognition by applying the neural network to image fragments rather than to the entire image, and reducing each image fragment to the size of the network input layer, which results in significantly reducing the requirements to the computing resources consumed by the neural network, as compared to the baseline scenario of feeding the whole image to the neural network.

Systems and methods described herein may be implemented by hardware (e.g., general purpose and/or specialized processing devices, and/or other devices and associated circuitry), software (e.g., instructions executable by a processing device), or a combination thereof. Various aspects of the above referenced methods and systems are described in detail herein below by way of examples, rather than by way of limitation.

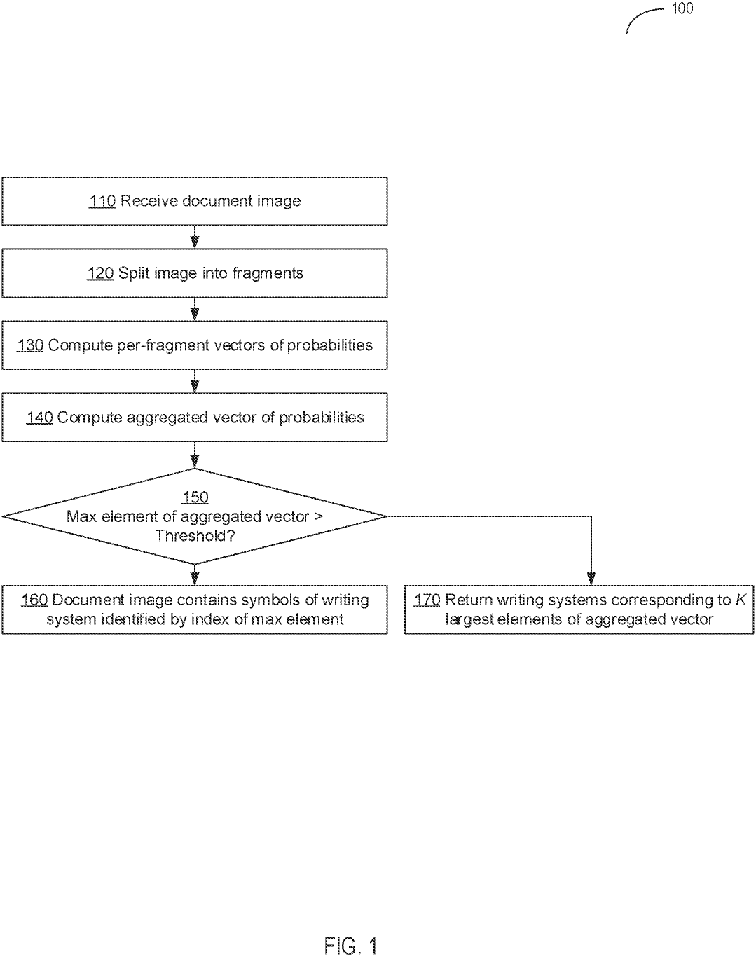

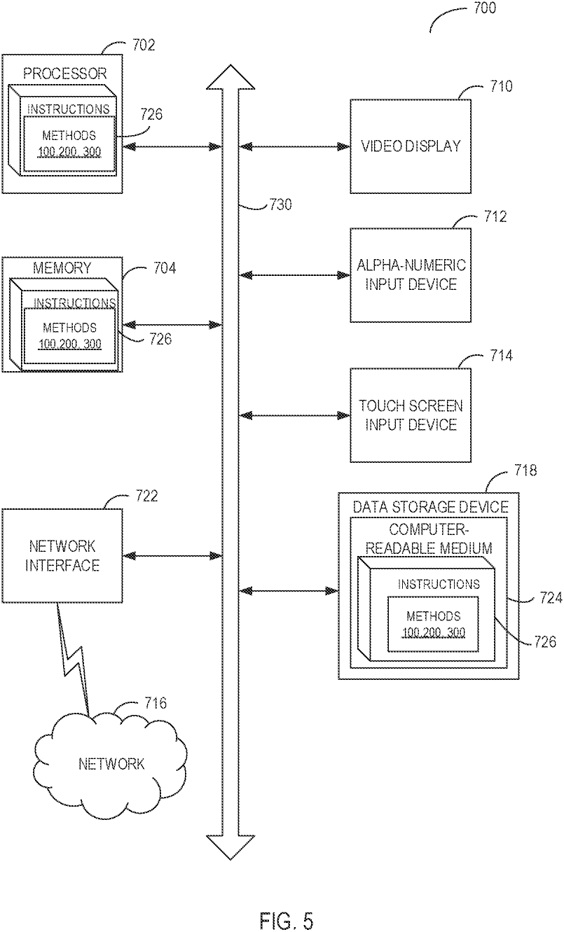

FIG. 1 depicts a flow diagram of an example method 100 of identifying the writing system utilized in a document, in accordance with one or more aspects of the present disclosure. Method 100 and/or each of its individual functions, routines, subroutines, or operations may be performed by one or more processors of the computer system (e.g., example computer system 700 of FIG. 5) executing the method. In certain implementations, method 100 may be performed by a single processing thread. Alternatively, method 100 may be performed by two or more processing threads, each thread executing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other. Therefore, while FIG. 1 and the associated description lists the operations of method 100 in certain order, various implementations of the method may perform at least some of the described operations in parallel and/or in arbitrary selected orders.

At operation 110, a computer system implementing the method receives the input document image. In some implementations, before being fed to the method 100, the input document image may be pre-processed, e.g., by cropping the original image, scaling the original image, and/or converting the original image into a gray scale or black-and-white image.

At operation 120, the computer system splits the original image into a predefined number of rectangular fragments by applying a rectangular grid. The requisite number of fragments may be computed a priori as providing a desired balance between the computational complexity and the accuracy of the result. In an illustrative example, the original image may be split into a 3 x 3 regular grid of nine rectangular fragments. In other examples, various other grids may be employed. The resulting rectangular fragments are compressed to a predefined size (e.g., 224 × 224 pixels), which may be computed a priori a providing a desired balance between the computational complexity and the accuracy of the result. In some implementations, the fragments may be further pre-processed, e.g., by normalizing the pixel brightness to bring it to a predefined range, such as (-1, 1).

At operation 130, the computer system sequentially feeds the pre-processed image fragments to a neural network, which produces a numeric vector that includes N+1 values (where N is the number of writing systems recognizable by the neural network), such that each element of the vector reflects the probability of the image fragment depicting symbols of the writing system identified by the index of the element of the vector (i.e., i-th elements of the vector reflects the probability of the image fragment depicting symbols of the i-th writing system). The last element of the vector reflects the probability of the image fragment depicting no recognizable symbols. Thus, for each fragment of the input image, the neural network would produce a corresponding vector of probabilities of the image fragment containing symbols of a respective writing system.

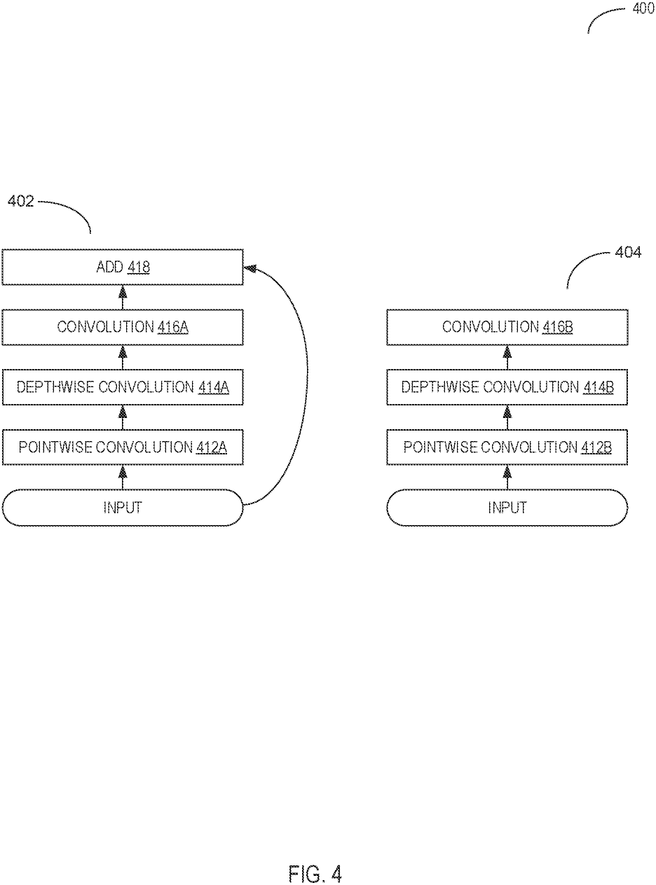

In some implementations, the neural network may be represented by a convolutional neural network following a specific architecture, as described in more detail herein below with reference to FIG. 4.

In some implementations, a second level classifier can be introduced, which receives a spatial feature map generated by the neural network at operation 130 and is trained to identify the writing system based on the spatial feature map.

In some implementations, the neural network at operation 130 and/or the second level classifier may be trained to perform multi-label classification that would yield two or more writing systems having their respective symbols present in the input document image.

At operation 140, the computer system aggregates the vectors produced by the neural network for the set of fragments of the input image, such that the resulting vector has the dimension of N+1, and the i-th component of the resulting vector is the sum of i-th components of all the vectors produced by the neural network for the set of fragments of the input image:

$${s}_{j} = {\sum }_{i = 1}^{n} {p}_{i j}$$

where sⱼ is the j-th component of the sum vector, and
pᵢⱼ is the j-th component of the probability vector produced by the neural network for the i-th image fragment.

The resulting vector may then be normalized, e.g., by dividing each element of the vector by the square root of the L2 norm of the vector:

$${s}_{i n o r m} = \frac{{s}_{i}}{\sqrt{{\left|\left|s\right|\right|}_{2}}}$$

where sᵢₙₒᵣₘ is the i-th component of the normalized resulting vector,
sᵢ is the i-th element of the vector, and

$${\left|\left|S\right|\right|}_{2}$$
is the L2 norm of the vector.

Responsive to determining, at operation 150, that sₘₐₓ = argmax sᵢ (i.e., the maximum value, among all elements of the normalized resulting vector) exceeds a predefined threshold, the computer system, at operation 160, concludes that the image contains symbols of the writing system identified by the index of the maximum element of the vector. Otherwise, if the maximum value is below or equal to the predefined threshold, a pre-defined number K (e.g., two) candidate writing systems that scored K largest values are returned at operation 170, and the method terminates. The predefined threshold may be computed a priori as providing a desired accuracy of recognition.

As noted herein above, the number of fragments in which the original image is split may be arbitrary, and may depend upon the type and/or other known parameters of the input document. In some implementations, the method 100 may be adapted to processing input documents that contain textual fragments that utilize fonts of different sizes (such as headings, normal text, subscripts and superscripts, etc.). In order for the network to yield a reliable response for a given fragment of the image, the fragment should contain several lines of text (i.e., contain a sufficient number of graphemes), while reducing the fragment to the size of the network input layer (e.g., 224×224), the text should remain large enough in order to allow identification of the writing system. These consideration may be utilized for determining the range of font sizes to be used for training the neural network.

Training the neural network may involve activating the neural network for every input in a training dataset. A value of a loss function may be computed based on the observed output of a certain layer of the neural network and the desired output specified by the training dataset, and the error may be propagated back to the previous layers of the neural network, in which the edge weights and/or other network parameters may be adjusted accordingly. This process may be repeated until the value of the loss function would stabilize in the vicinity of a certain value or fall below a predetermined threshold.

In order for a trained network to be able to produce reliable results on arbitrary font sizes, including the font sizes falling outside of the range of font sizes on which the neural network has been trained, the method 100 may be modified to utilize scaled image fragments. In order to allow processing wide ranges of font sizes, the neural network may be trained to yield a new category of images, which would correspond to the text being too small to accurately recognize the writing system.

Thus, upon processing the original image reduced to the size corresponding to the size of the network input layer, the neural network may be fed multiple image fragments, which may be produced, e.g., by applying a predefined grid (e.g., 2 x 2 regular grid of four rectangular fragments) to the original image. The grid may recursively be applied to the image fragments that were characterized by the network as containing the text which is too small for allowing accurate recognition, until all fragments would not contain sufficiently large symbols which would allow the neural network to recognize the writing system, or until the predefined minimum image fragment size is reached.

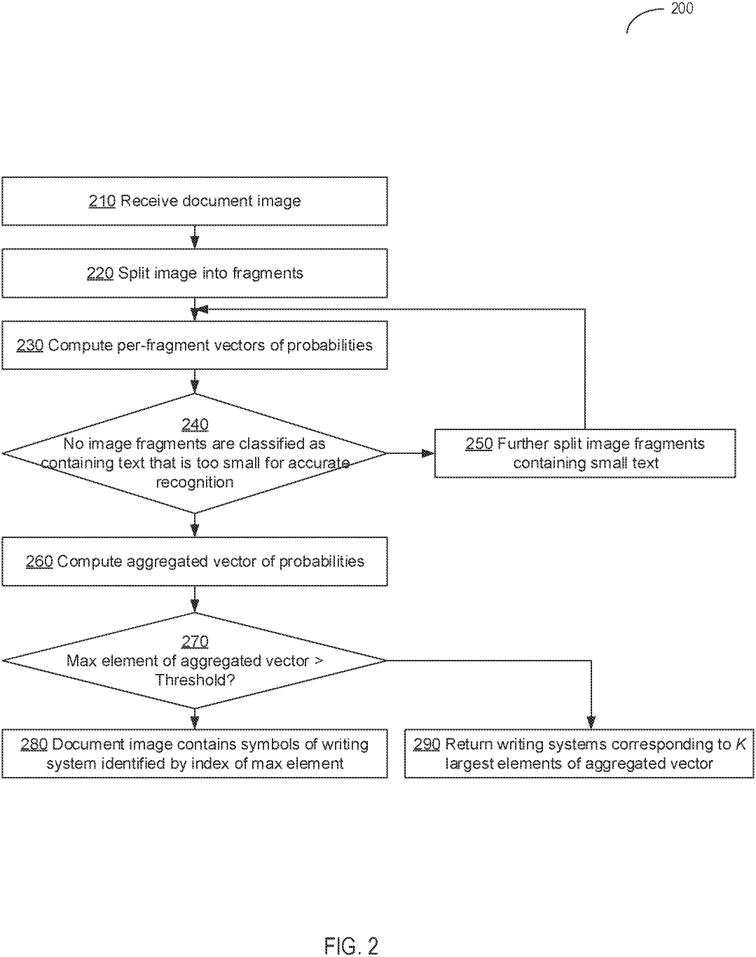

FIG. 2 depicts a flow diagram of an example method 200 of identifying the writing system utilized in a document, in accordance with one or more aspects of the present disclosure. Method 200 and/or each of its individual functions, routines, subroutines, or operations may be performed by one or more processors of the computer system (e.g., example computer system 700 of FIG. 5) executing the method. In certain implementations, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other. Therefore, while FIG. 2 and the associated description lists the operations of method 200 in certain order, various implementations of the method may perform at least some of the described operations in parallel and/or in arbitrary selected orders.

At operation 210, a computer system implementing the method receives the input document image. In some implementations, before being fed to the method 200, the input document image may be pre-processed, e.g., by cropping the original image, scaling the original image, and/or converting the original image into a gray scale or black-and-white image.

At operation 220, the computer system splits the original image into a predefined number of rectangular fragments by applying a rectangular grid, as described in more detail herein above. The resulting rectangular fragments are compressed to a predefined size (e.g., 224 × 224 pixels), which may be computed a priori a providing a desired balance between the computational complexity and the accuracy of the result. In some implementations, the fragments may be further pre-processed, e.g., by normalizing the pixel brightness to bring it to a predefined range, such as (-1, 1).

At operation 230, the computer system sequentially feeds the pre-processed image fragments to a neural network, which produces, for each fragment of the input image, a corresponding vector of probabilities of the image fragment containing symbols of a respective writing system, as described in more detail herein above. In some implementations, the neural network may be represented by a convolutional neural network following a specific architecture, as described in more detail herein below with reference to FIG. 4.

Responsive to determining, at operation 240 that the neural network classified no image fragments as containing no the text which is too small for allowing accurate recognition or that a predefined minimum image fragment size is reached, the processing continues at block 260; otherwise, the method branches to operation 250.

At operation 250, the computer system further splits, into multiple sub-fragments, the image fragments that the network characterized as containing the text which is too small for allowing accurate recognition, and the method loops back to block 230.

At operation 260, the computer system aggregates the vectors produced by the neural network for the set of fragments of the input image, such that the resulting vector has the dimension of N+1, and the i-th component of the resulting vector is the sum of i-th components of all the vectors produced by the neural network for the set of fragments of the input image. The resulting vector may then be normalized, as described in more detail herein above.

Responsive to determining, at operation 270, that the maximum value, among all elements of the normalized resulting vector, exceeds a predefined threshold, the computer system, at operation 280, concludes that the image contains symbols of the writing system identified by the index of the maximum element of the vector. Otherwise, if the maximum value is below or equal to the predefined threshold, a pre-defined number K of candidate writing systems that scored K largest values are returned at operation 290, and the method terminates.

In some implementations, in order to reduce the processing time, only a subset of all image fragments (e.g., “regions of interest” (ROIs)) may be fed to the neural network for further processing. In order to improve the overall efficiency of the method, the selected image fragments may not necessarily cover the whole image, and/or may be selected in a predefined order, e.g., in a staggered order. In another illustrative example, the writing system identification neural network may be run on a full set of image fragments.

The training dataset utilized for training the ROI identification neural network may then be composed of at least a subset of all image fragments and their respective values of accuracy of inference exhibited by the writing system identification neural network. The image fragments may then be sorted in the reverse order of the accuracy of inference performed by the writing system identification neural network. A predefined number of image fragments corresponding to the highest accuracy of inference performed on those fragments by the writing system identification neural network may then be selected and utilized for training the ROI identification neural network.

In another illustrative example, the smooth ground truth approach may be implemented, which involves storing, in a segmentation data structure (e.g., a heatmap), the respective per-segment probabilities that have been yielded by the classifier. The segmentation data structure may then be utilized for training a writing system identification neural network, by selecting a predefined number (e.g., N) of best fragments (e.g., by selecting M maximum superpixels from the heatmap) for running the classifier. In order to improve the efficiency, the heatmap may be sorted by counting, which exhibits the computational complexity of O(N), where N is the number of superpixels in the heatmap. The classifier may subsequently be re-trained to specifically fit these selected fragments, which may be achieved by weighting the lost function on a per-fragment basis. Upon selecting the predefined number of fragments (regions of interest), the re-trained classifier may be run upon them to yield the predefined number of probabilities, which may be aggregated as described herein above.

In some implementations, the ROI identification neural network may be trained to process wide ranges of font sizes. The writing system identification neural network may be trained to identify the writing system for documents utilizing a predefined font size range (e.g., font sizes from X to 2X). The writing system identification neural network may then be run on image fragments of various scales. The training dataset utilized for training the ROI identification neural network may then be composed of all image fragments and their respective values of accuracy of inference exhibited by the writing system identification neural network.

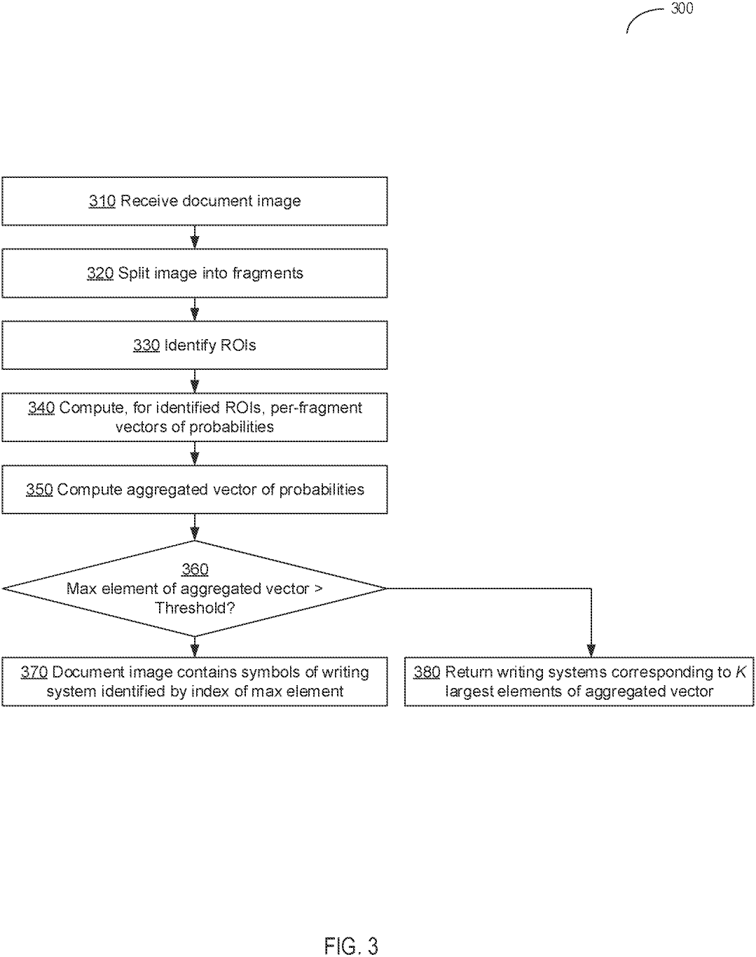

FIG. 3 depicts a flow diagram of an example method 300 of identifying the writing system utilized in a document, in accordance with one or more aspects of the present disclosure. Method 300 and/or each of its individual functions, routines, subroutines, or operations may be performed by one or more processors of the computer system (e.g., example computer system 700 of FIG. 5) executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other. Therefore, while FIG. 3 and the associated description lists the operations of method 300 in certain order, various implementations of the method may perform at least some of the described operations in parallel and/or in arbitrary selected orders.

At operation 310, a computer system implementing the method receives the input document image. In some implementations, before being fed to the method 300, the input document image may be pre-processed, as described in more detail herein above.

At operation 320, the computer system splits the original image into a predefined number of rectangular fragments by applying a rectangular grid, as described in more detail herein above.

At operation 330, the computer system identify, among all image fragments, the regions of interest (ROIs). In some implementations, the ROI identification may be performed by a dedicated ROI identification neural network, which may identify a subset including a predefined number of image fragments, as described in more detail herein above.

At operation 340, the computer system sequentially feeds the pre-processed image fragments to a neural network, which produces, for each pre-processed fragment of the input image, a corresponding vector of probabilities of the image fragment containing symbols of a respective writing system, as described in more detail herein above. In some implementations, the neural network may be represented by a convolutional neural network following a specific architecture, as described in more detail herein below with reference to FIG. 4.

At operation 350, the computer system aggregates the vectors produced by the neural network for the set of fragments of the input image, such that the resulting vector has the dimension of N+1, and the i-th component of the resulting vector is the sum of i-th components of all the vectors produced by the neural network for the set of fragments of the input image. The resulting vector may then be normalized, as described in more detail herein above.

Responsive to determining, at operation 360, that the maximum value, among all elements of the normalized resulting vector, exceeds a predefined threshold, the computer system, at operation 370, concludes that the image contains symbols of the writing system identified by the index of the maximum element of the vector. Otherwise, if the maximum value is below or equal to the predefined threshold, a pre-defined number K of candidate writing systems that scored K largest values are returned at operation 380, and the method terminates.

Furthermore, in some implementations, the writing system identification neural network may be utilized for identifying both the writing system and the spatial orientation of an input image. Accordingly, the neural network may be modified to include an additional output, which would produce a value describing the spatial orientation of the input image. In an illustrative example, the value may reflect one of the four possible orientations: normal, rotated by 90 degrees clockwise or counterclockwise, rotated by 180 degrees, rotated by 270 degrees clockwise or counterclockwise, etc. Similarly to writing system identification, the spatial orientation may be determined for a set of fragments of an input image and then aggregated over all fragments in order to determine the spatial orientation of the input image. In some implementations, the spatial image orientation may be identified by a second level classifier, which receives a spatial feature map generated by the neural network at operation 130 and is trained to identify the spatial orientation of the input image.

Similarly to datasets that are utilized for training writing system identification neural networks, a dataset for training the network to recognize image orientation may be composed of a real-life and/or synthetic images. Such a training dataset may include images that have different spatial orientations, such that the image orientation is distributed either uniformly or based on the frequency of occurrence of document images having various orientations in a given corpus of documents.

As noted herein above, a neural network implemented in accordance with aspects of the present disclosure may include multiple layers of different types. In an illustrative example, an input image may be received by the input layer and may be subsequently processed by a series of layers, including convolutional layers, pooling layers, rectified linear unit (ReLU) layers, and/or fully connected layers, each of which may perform a particular operation in recognizing the text in an input image. A layer’s output may be fed as the input to one or more subsequent layers. Processing of the original image by the convolutional neural network may iteratively apply each successive layer until every layer has performed its respective operation.

In some implementations, a convolutional neural network may include alternating convolutional layers and pooling layers. Each convolution layer may perform a convolution operation that involves processing each pixel of an input image fragment by one or more filters (convolution matrices) and recording the result in a corresponding position of an output array. One or more convolution filters may be designed to detect a certain image feature, by processing the input image and yielding a corresponding feature map.

The output of a convolutional layer may be fed to a ReLU layer, which may apply a non-linear transformation (e.g., an activation function, which replaces negative numbers by zero) to process the output of the convolutional layer. The output of the ReLU layer may be fed to a pooling layer, which may perform a subsampling operation to decrease the resolution and the size of the feature map. The output of the pooling layer may be fed to the next convolutional layer.

In some implementations, writing system identification neural networks implemented in accordance with aspects of the present disclosure may be compliant to a MobileNet architecture, which is a family of general purpose computer vision neural networks designed for mobile devices in order to perform image classification, detection, and/or various similar tasks. In an illustrative example, writing system identification neural network may follow MobileNetv2 architecture, as schematically illustrated by FIG. 4. As shown in FIG. 4, example neural network 400 may include two types of blocks. Block 402 is a residual block with the stride of one. Block 402 is a block with the stride of two.

Each of the blocks 402, 404 include three layers: pointwise convolution layer 412A-412B, which is responsible for building new features through computing linear combinations of the input channels; deepthwise convolution layer 414A-414B which performs lightweight filtering by applying a single convolutional filter per input channel; and second convolution layer 416A-416B without non-linearity. When the initial and final feature maps are of the same dimensions (when the depth-wise convolution stride equals one and input and output channels are equal), a residual connection 418 is added to aid gradient flow during backpropagation.

In another illustrative example, writing system identification neural network may follow MobileNetv3 architecture, all blocks of which are bottleneck blocks with squeeze and excite mechanisms. The neural network may have four common layers for feature extraction, followed by three branches: the writing system identification branch, the spatial orientation identification branch, and the text size clustering branch. The latter may be utilized for post-processing and selection of patches for performing further classification of the scaled text. Each branch may include a predetermined number of blocks (e.g., three or four).

While FIG. 4 and associated description illustrates a certain number and types of layers of the example convolutional neural network architecture, convolutional neural networks employed in various alternative implementations may include any suitable numbers of convolutional layers, ReLU layers, pooling layers, and/or any other layers. The order of the layers, the number of the layers, the number of filters, and/or any other parameter of the convolutional neural networks may be adjusted (e.g., based on empirical data).

The neural networks utilized by the systems and methods of the present disclosure may be trained on training datasets including real-life and/or synthetic images of text. Various image augmentation methods may be applied to the synthetic images in order to achieve the “photorealistic” image quality. Each image may include several lines of text in a certain language, which are rendered using a specified font size. The language utilized in the image determines the writing system, which is utilized as the label associated with the image fragment in training the neural network.

FIG. 5 depicts a component diagram of an example computer system which may be employed for implementing the methods described herein. The computer system 700 may be connected to other computer system in a LAN, an intranet, an extranet, or the Internet. The computer system 700 may operate in the capacity of a server or a client computer system in client-server network environment, or as a peer computer system in a peer-to-peer (or distributed) network environment. The computer system 700 may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methods described herein.

Exemplary computer system 700 includes a processor 702, a main memory 704 (e.g., read-only memory (ROM) or dynamic random access memory (DRAM)), and a data storage device 718, which communicate with each other via a bus 730.

Processor 702 may be represented by one or more general-purpose processing devices such as a microprocessor, central processing unit, or the like. More particularly, processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute instructions 726 for performing the methods described herein.

Computer system 700 may further include a network interface device 722, a video display unit 710, a character input device 712 (e.g., a keyboard), and a touch screen input device 714.

Data storage device 718 may include a computer-readable storage medium 724 on which is stored one or more sets of instructions 726 embodying any one or more of the methods or functions described herein. Instructions 726 may also reside, completely or at least partially, within main memory 704 and/or within processor 702 during execution thereof by computer system 700, main memory 704 and processor 702 also constituting computer-readable storage media. Instructions 726 may further be transmitted or received over network 716 via network interface device 722.

In an illustrative example, instructions 726 may include instructions of methods 100, 200, and/or 300 for identifying the writing system utilized in a document, implemented in accordance with one or more aspects of the present disclosure. While computer-readable storage medium 724 is shown in the example of FIG. 5 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methods of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, graphemes, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computer system, that manipulates and transforms data represented as physical (e.g., electronic) quantities within the computer system’s registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

1. A method, comprising:
receiving, by a computer system, a document image;
splitting the document image into a plurality of image fragments;
generating, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector;
computing an aggregated probability vector by aggregating the plurality of probability vectors, wherein each numeric element of the aggregated probability vector reflects a probability of the image containing a text associated with a writing system that is identified by an index of the numeric element within the aggregated probability vector; and
responsive to determining that a maximum numeric element of the aggregated probability vector exceeds a predefined threshold value, concluding that the document image contains one or more symbols associated with a writing system that is identified by an index of the maximum numeric element within the aggregated probability vector.

2. The method of claim 1, further comprising:
responsive to determining that a maximum numeric element of the aggregated probability vector is below or equal the predefined threshold value, concluding that the document image contains one or more symbols associated with one of: a first writing system that is identified by a first index of the maximum numeric element within the aggregated probability vector or a second writing system that is identified by a second index of a next largest numeric element within the aggregated probability vector.

3. The method of claim 1, further comprising:
identifying, among the plurality of image fragments, a plurality of region of interest (ROIs).

4. The method of claim 1, further comprising:
normalizing the aggregated probability vector.

5. The method of claim 1, wherein each image fragment of the plurality of image fragments is a rectangular image fragment of a predefined size.

6. The method of claim 1, further comprising:
recursively splitting, into respective image sub-fragments, one or more image fragments that are characterized by the neural network as containing a text having a text size below a minimum threshold size.

7. The method of claim 1, further comprising:
pre-processing the document image.

8. The method of claim 1, wherein splitting the document image into a plurality of image fragments further comprises:
transforming each image fragment of the plurality of image fragments to a predefined size.

9. The method of claim 1, further comprising:
determining, by the neural network processing the plurality of image fragments, a spatial orientation of the document image.

10. The method of claim 1, further comprising:
identifying, based on a predefined order, a subset of the plurality of image fragments to be fed to the neural network.

11. A system, comprising:
a memory;
a processor, coupled to the memory, the processor configured to:
receive a document image;
split the document image into a plurality of image fragments;
generate, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector;
compute an aggregated probability vector by aggregating the plurality of probability vectors, wherein each numeric element of the aggregated probability vector reflects a probability of the image containing a text associated with a writing system that is identified by an index of the numeric element within the aggregated probability vector; and
responsive to determining that a maximum numeric element of the aggregated probability vector exceeds a predefined threshold value, conclude that the document image contains one or more symbols associated with a writing system that is identified by an index of the maximum numeric element within the aggregated probability vector.

12. The system of claim 11, wherein the processor is further configured to:
responsive to determining that a maximum numeric element of the aggregated probability vector is below or equal the predefined threshold value, conclude that the document image contains one or more symbols associated with one of: a first writing system that is identified by a first index of the maximum numeric element within the aggregated probability vector or a second writing system that is identified by a second index of a next largest numeric element within the aggregated probability vector.

13. The system of claim 11, wherein each image fragment of the plurality of image fragments is a rectangular image fragment of a predefined size.

14. The system of claim 11, wherein the processor is further configured to:
recursively split, into respective image sub-fragments, one or more image fragments that are characterized by the neural network as containing a text having a text size below a minimum threshold size.

15. The system of claim 11, wherein splitting the document image into a plurality of image fragments further comprises:
transforming each image fragment of the plurality of image fragments to a predefined size.

16. The system of claim 11, wherein the processor is further configured to:
determine, by the neural network processing the plurality of image fragments, a spatial orientation of the document image.

17. A computer-readable non-transitory storage medium comprising executable instructions that, when executed by a computer system, cause the computer system to:
receive a document image;
split the document image into a plurality of image fragments;
generating, by a neural network processing the plurality of image fragments, a plurality of probability vectors, wherein each probability vector of the plurality of probability vectors is produced by processing a corresponding image fragments and contains a plurality of numeric elements, and wherein each numeric element of the plurality of numeric elements reflects a probability of the image fragment containing a text associated with a writing system that is identified by an index of the numeric element within the respective probability vector;
compute an aggregated probability vector by aggregating the plurality of probability vectors, wherein each numeric element of the aggregated probability vector reflects a probability of the image containing a text associated with a writing system that is identified by an index of the numeric element within the aggregated probability vector; and
responsive to determining that a maximum numeric element of the aggregated probability vector exceeds a predefined threshold value, conclude that the document image contains one or more symbols associated with a writing system that is identified by an index of the maximum numeric element within the aggregated probability vector.

18. The computer-readable non-transitory storage medium of claim 17, further comprising executable instructions that, when executed by the computer system, cause the computer system to:
responsive to determining that a maximum numeric element of the aggregated probability vector is below or equal the predefined threshold value, conclude that the document image contains one or more symbols associated with one of: a first writing system that is identified by a first index of the maximum numeric element within the aggregated probability vector or a second writing system that is identified by a second index of a next largest numeric element within the aggregated probability vector.

19. The computer-readable non-transitory storage medium of claim 17, wherein splitting the document image into a plurality of image fragments further comprises:
transforming each image fragment of the plurality of image fragments to a predefined size.

20. The computer-readable non-transitory storage medium of claim 17, further comprising executable instructions that, when executed by the computer system, cause the computer system to:
determine, by the neural network processing the plurality of image fragments, a spatial orientation of the document image.
